(19) United States
(12) Patent Application Publication
(10) Pub. No.: US 2006/0291565 A1
(43) Pub. Date: Dec. 28, 2006

(54) System and method for performing video block prediction

(76) Inventor: Eddie Y. Chen, Fremont, CA (US)

Correspondence Address: MCANDREWS HELD & MALLOY, LTD, 500 WEST MADISON STREET, SUITE 3400, CHICAGO, IL, 60661, US

(21) Appl. No.: 11/158,583

(22) Filed: Jun. 22, 2005

(51) Int. Cl. H04N 11/04; H04N 7/12; H04N 11/02; H04B 1/66

(52) U.S. Cl. 375/240.24; 375/240.25

(57) ABSTRACT

A system and method for performing video block prediction. Various aspects of the present invention may comprise a first module adapted to receive, during a first time interval, first luma information of previously decoded horizontal luma pixels and calculate a first luma prediction coefficient based on such information. A second module may be adapted to receive, during the first time interval, second luma information of previously decoded vertical luma pixels and calculate a second luma prediction coefficient based on such information. A third module may be adapted to receive, during the first time interval, third luma information of previously decoded horizontal and vertical luma pixels, and calculate a third luma prediction coefficient based on such information. A fourth module may be adapted to receive the first, second and third luma prediction coefficients and pixel coordinate information, and generate a luma pixel prediction value corresponding to the pixel coordinate information.

### CROSS-REFERENCE TO RELATED APPLICATIONS/INCORPORATION BY REFERENCE

[Not Applicable]

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

Various video communication standards utilize video block encoding to encode video information for efficient communication. Receivers of such block encoded video information must generally decode such encoded video information prior to presenting the video information to a user. An example of such block encoding may, for example and without limitation, be found in the MPEG-4 (e.g., MPEG-4, part 10) standard.

During the decoding process, particular decoding methodologies may include implementing various equations, some of which include series calculations and multiplication. For example, calculating intra plane pixel predictions may include performing series and multiplication calculations involving previously decoded video pixels from adjacent video blocks (e.g., left block, upper-left block, upper block, and upper-right block). Implementing such equations in a real-time system may include circuitry corresponding to relatively high gate count, relatively high cost and/or relatively high latency.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention provide a system and method for performing video block prediction, substantially as shown in and/or described in connection with at least one of the figures, as set forth more completely in the claims. These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 is a diagram illustrating a system for performing video block prediction, in accordance with various aspects of the present invention.

FIG. 2 is a diagram illustrating a system for performing video block prediction, in accordance with various aspects of the present invention.

FIG. 3 is a diagram illustrating a video processing system, in accordance with various aspects of the present invention.

FIG. 4 is a flow diagram illustrating a method for performing video block prediction, in accordance with various aspects of the present invention.

### DETAILED DESCRIPTION OF THE INVENTION

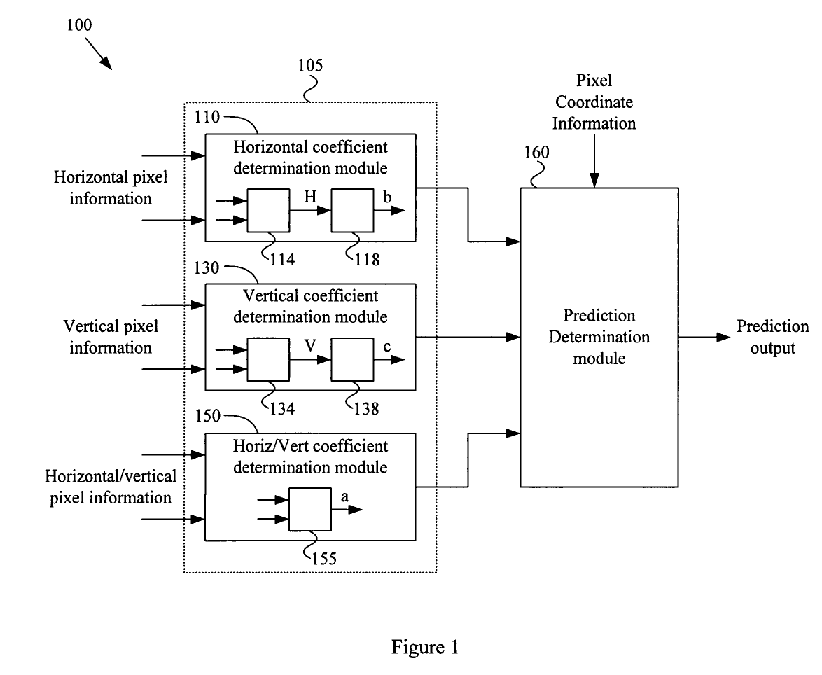

FIG. 1 is a diagram illustrating a system 100 for performing video block prediction, in accordance with various aspects of the present invention. The exemplary system 100 may be implemented in any of a variety of video processing systems. For example and without limitation, the exemplary system 100 may be implemented in a video decoder chip. Also for example, the exemplary system 100 may be implemented in a television, computer, mobile communication device, cable television box, satellite television receiver, etc. The scope of various aspects of the present invention should not be limited by characteristics of any particular implementation or utilization of the system 100.

The exemplary system 100 may comprise a coefficient determination module 105 that generally receives information comprising previously decoded video information and generates one or more prediction coefficients. The exemplary system 100 may also comprise a prediction determination module 160, communicatively coupled to the coefficient determination module 105, that generally receives coefficient information from the coefficient determination module 105 and generates video prediction information (e.g., video block prediction information).

The coefficient determination module 105 may, for example, comprise a horizontal coefficient determination module 110. The horizontal coefficient determination module 110 may, for example, be adapted to receive (e.g., during a first time interval) first luma information of a plurality of previously decoded horizontal luma pixels and calculate a first luma prediction coefficient based, at least in part, on the first luma information. The horizontal coefficient determination module 110 may also, for example, be adapted to receive, during a second time interval, first chroma information of a plurality of previously decoded horizontal chroma pixels and calculate a first chroma prediction coefficient based, at least in part, on the first chroma information. In various non-limiting exemplary scenarios, the horizontal coefficient determination module 110 may be adapted to process (e.g., serially) both horizontal luma and horizontal chroma information through identical or substantially identical data (or signal).

The horizontal coefficient determination module 110 may, for example and without limitation, comprise a first sub-module 114 adapted to implement the equation:

$${H}_{luma} = {\sum }_{{x}^{′} = 0}^{7} ( {x}^{′} + 1 ) * ( p [ 8 + {x}^{′} , - 1 ] - p [ 6 - {x}^{′} , - 1 ] ) . \qquad equation 1$$

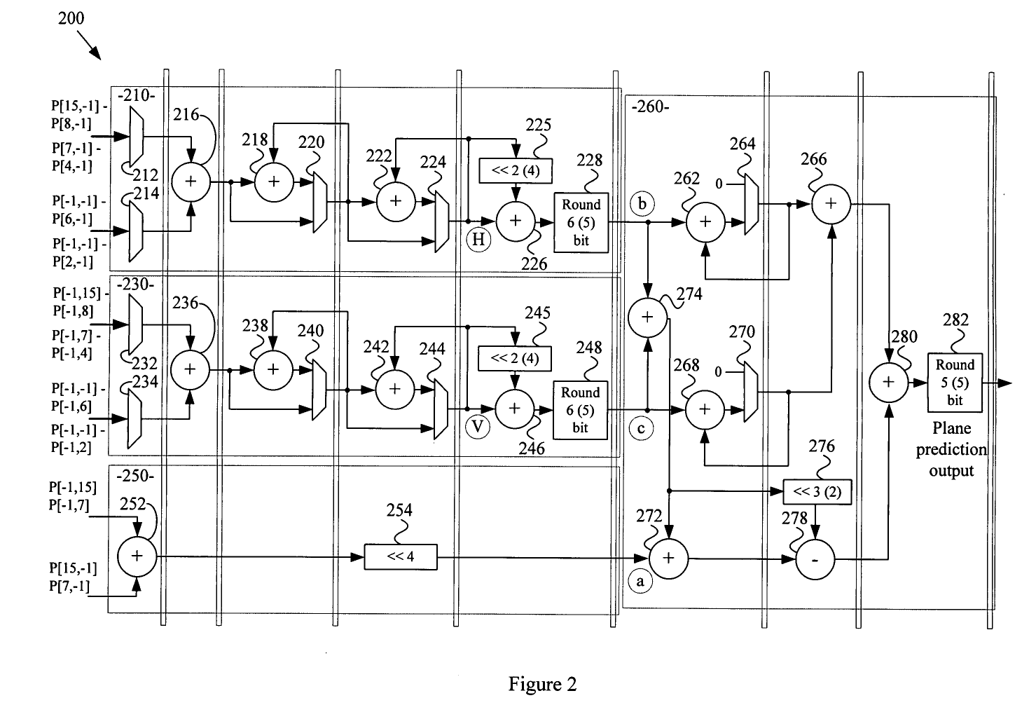

As will be exemplified in a non-limiting manner in the system 200 illustrated in FIG. 2, the first sub-module 114 may comprise a set of serially connected accumulators adapted to implement equation 1 (e.g., without utilizing a multiplier circuit).

The first sub-module 114 may also, for example and without limitation, be adapted to implement the equation:

$${H}_{chroma} = {\sum }_{{x}^{′} = 0}^{3} ( {x}^{′} + 1 ) * ( p [ 4 + {x}^{′} , - 1 ] - p [ 2 - {x}^{′} , - 1 ] ) . \qquad equation 2$$

As will be exemplified in a non-limiting manner in the system 200 illustrated in FIG. 2, the first sub-module 114 may comprise a set of serially connected accumulators adapted to implement equation 2 (e.g., without utilizing a multiplier circuit). In various exemplary scenarios, the same set (or substantially the same set) of serially connected accumulators may be adapted to implement both equation 1 and equation 2 (e.g., serially).

The horizontal coefficient determination module 110 may, for example and without limitation, comprise a second sub-module 118 adapted to implement the equation:
bₗᵤₘₐ=(5*Hₗᵤₘₐ+32)>>6. equation 3

As will be exemplified in a non-limiting manner in the system 200 illustrated in FIG. 2, the second sub-module 118 may comprise an adder and shift register, among other circuitry, that are adapted to implement equation 3 (e.g., without utilizing a multiplier circuit).

The second sub-module 118 may also, for example and without limitation, be adapted to implement the equation:
b_{chroma}=(17*H_{chroma}+16)>>5. equation 4

As will be exemplified in a non-limiting manner in the system 200 illustrated in FIG. 2, the second sub-module 118 may comprise an adder and shift register, among other circuitry, that are adapted to implement equation 4 (e.g., without utilizing a multiplier circuit). In various exemplary scenarios, the same circuitry (e.g., the adder and shift register) may be adapted to implement both equation 3 and equation 4 (e.g., serially).

The coefficient determination module 105 may, for example, comprise a vertical coefficient determination module 130. The vertical coefficient determination module 130 may, for example, be adapted to receive (e.g., during a first time interval) second luma information of a plurality of previously decoded vertical luma pixels and calculate a second luma prediction coefficient based, at least in part, on the second luma information. The vertical coefficient determination module 130 may also, for example, be adapted to receive (e.g., during a second time interval) second chroma information of a plurality of previously decoded vertical chroma pixels and calculate a second chroma prediction coefficient based, at least in part, on the second chroma information. In various non-limiting exemplary scenarios, the vertical coefficient determination module 130 may be adapted to process both (e.g., serially) vertical luma and vertical chroma information through identical or substantially identical data (or signal) paths.

The vertical coefficient determination module 130 may, for example and without limitation, comprise a first sub-module 134 adapted to implement the equation:

$${V}_{luma} = {\sum }_{{y}^{′} = 0}^{7} ( {y}^{′} + 1 ) * ( p [ - 1 , 8 + {y}^{′} ] - p [ - 1 , 6 - {y}^{′} ] ) . \qquad equation 5$$

As will be exemplified in a non-limiting manner in the system 200 illustrated in FIG. 2, the first sub-module 134 may comprise a set of serially connected accumulators adapted to implement equation 5 (e.g., without utilizing a multiplier circuit).

The first sub-module 134 may also, for example and without limitation, be adapted to implement the equation:

$${V}_{chroma} = {\sum }_{{y}^{′} = 0}^{3} ( {y}^{′} + 1 ) * ( p [ - 1 , 4 + {y}^{′} ] - p [ - 1 , 2 - {y}^{′} ] ) . \qquad equation 6$$

As will be exemplified in a non-limiting manner in the system 200 illustrated in FIG. 2, the first sub-module 134 may comprise a set of serially connected accumulators adapted to implement equation 6 (e.g., without utilizing a multiplier circuit). In various exemplary scenarios, the same set (or substantially the same set) of serially connected accumulators may be adapted to implement both equation 5 and equation 6 (e.g., serially).

The vertical coefficient determination module 130 may, for example and without limitation, comprise a second sub-module 138 adapted to implement the equation:
cₗᵤₘₐ=(5*Vₗᵤₘₐ+32)>>6. equation 7

As will be exemplified in a non-limiting manner in the system 200 illustrated in FIG. 2, the second sub-module 138 may comprise an adder and shift register, among other circuitry, that are adapted to implement equation 7 (e.g., without utilizing a multiplier circuit).

The second sub-module 138 may also, for example and without limitation, be adapted to implement the equation:
c_{chroma}=(17*V_{chroma}+16)>>5. equation 8

As will be exemplified in a non-limiting manner in the system 200 illustrated in FIG. 2, the second sub-module 138 may comprise an adder and shift register, among other circuitry, that are adapted to implement equation 8 (e.g., without utilizing a multiplier circuit). In various exemplary scenarios, the same circuitry (e.g., the adder and shift register) may be adapted to implement both equation 7 and equation 8 (e.g., serially).

The coefficient determination module 1 OS may also comprise a horizontal/vertical coefficient determination module 150. The horizontal/vertical coefficient determination module 150 may, for example, be adapted to receive (e.g., during the first time interval) third luma information of at least one previously decoded horizontal luma pixel and vertical luma pixel and calculate a third luma prediction coefficient based, at least in part, on the third luma information. The horizontal/vertical coefficient determination module 150 may also, for example, be adapted to receive (e.g., during the second time interval) third chroma information of at least one previously decoded horizontal chroma pixel and vertical chroma pixel and calculate a third chroma prediction coefficient based, at least in part, on the third chroma information. In various non-limiting exemplary scenarios, the horizontal/vertical coefficient determination module 150 may be adapted to process both (e.g., serially) horizontal/vertical luma and horizontal/vertical chroma information through identical or substantially identical data (or signal) paths.

The horizontal/vertical coefficient determination module 150 may, for example and without limitation, comprise a sub-module 155 adapted to implement the equation:
aₗᵤₘₐ=16*(p[−1,15]+p[15,−1]). equation 9

As will be exemplified in a non-limiting manner in the system 200 illustrated in FIG. 2, the sub-module 155 may comprise a set of addition circuitry, difference circuitry and shift circuitry adapted to implement equation 9 (e.g., without utilizing a multiplier circuit).

The sub-module 155 may also, for example and without limitation, be adapted to implement the equation:
a_{chroma}=16*(p[−1,7]+p[7,−1]). equation 10

As will be exemplified in a non-limiting manner in the system 200 illustrated in FIG. 2, the sub-module 155 may comprise a set of addition circuitry, difference circuitry and shift circuitry adapted to implement equation 10 (e.g., without utilizing a multiplier circuit). In various exemplary scenarios, the same set (or substantially the same set) of circuitry may be adapted to implement both equation 9 and equation 10 (e.g., serially).

In a non-limiting exemplary scenario, during a first time interval, the horizontal coefficient determination module 110 may receive first luma information of a plurality of previously decoded horizontal luma pixels and propagate the first luma information through a first data path to generate a first luma prediction coefficient. The horizontal coefficient determination module 110 may then, for example during a second time interval, receive first chroma information of a plurality of previously decoded horizontal chroma pixels and propagate the first chroma information through the first data path (or a data path substantially similar to the first data path) to generate a first chroma prediction coefficient.

Continuing the non-limiting exemplary scenario, the first data path may comprise addition circuitry and difference circuitry to implement equation 1 and equation 2 in the absence of multiplier circuitry. For example, the first data path may comprise a plurality of serially-connected accumulators to generate a prediction coefficient based, at least in part, on a series of terms that include multiplication operations. Also for example, the first data path may comprise addition and shifting circuitry to implement equation 3 and equation 4 in the absence of multiplier circuitry.

Continuing the non-limiting exemplary scenario, during the first time interval, the vertical coefficient determination module 130 may receive second luma information of a plurality of previously decoded vertical luma pixels and propagate the second luma information through a second data path to generate a second luma prediction coefficient. The vertical coefficient determination module 130 may then, for example during the second time interval, receive second chroma information of a plurality of previously decoded vertical chroma pixels and propagate the second chroma information through the second data path (or a data path substantially similar to the second data path) to generate a second chroma prediction coefficient.

Continuing the non-limiting exemplary scenario, the second data path may comprise addition circuitry and difference circuitry to implement equation 5 and equation 6 in the absence of multiplier circuitry. For example, the second data path may comprise a plurality of serially connected accumulators to generate a prediction coefficient based, at least in part, on a series of terms that include multiplication operations. Also for example, the first data path may comprise addition and shifting circuitry to implement equation 7 and equation 8 in the absence of multiplier circuitry.

Continuing the non-limiting exemplary scenario, during the first time interval, the horizontal/vertical coefficient determination module 150 may receive third luma information of at least one previously decoded horizontal luma pixel and vertical luma pixel and propagate the third luma information through a third data path to generate a third luma prediction coefficient. The horizontal/vertical coefficient determination module 150 may then, for example during the second time interval, receive third chroma information of at least one previously decoded horizontal chroma pixel and vertical chroma pixel and propagate the third chroma information through the third data path (or a path substantially similar to the third data path) to generate a third chroma prediction coefficient.

Continuing the non-limiting exemplary scenario, the third data path may comprise addition and/or difference circuitry and shift circuitry to implement equations 9 and 10 in the absence of multiplier circuitry.

As mentioned previously, the exemplary system 100 may comprise a prediction determination module 160. The prediction determination module 160 may, for example and without limitation, be adapted to receive (e.g., during the first time interval) the first luma prediction coefficient, the second luma prediction coefficient and the third luma prediction coefficient. The prediction determination module 160 may further, for example, be adapted to receive (e.g., during the second time interval) the first chroma prediction coefficient, the second chroma prediction coefficient and the third chroma prediction coefficient. The prediction determination module 160 may additionally, for example, be adapted to receive pixel coordinate information (not shown). Such pixel coordinate information may, for example, comprise a horizontal pixel coordinate and a vertical pixel coordinate. The prediction determination module 160 may also, for example, be adapted to process such received information (i.e., luma coefficient information, chroma coefficient information and pixel coordinate information) and generate a luma and chroma pixel predictions corresponding to the coordinate information.

The prediction determination module 160 may, for example and without limitation, be adapted to implement the equation:
pred_{L}[x,y]=Clip1((a+b*(x−7)+c*(y−7)+16)>>5) equation 11

with x, y=0 . . . 15, “a” defined by equation 9, “b” defined by equation 3 and “c” defined by equation 7.

As will be exemplified in a non-limiting manner in the system 200 illustrated in FIG. 2, the prediction determination module 160 may comprise a set of addition (and/or difference) circuits, shifters and rounding circuits adapted to implement equation 11 (e.g., without utilizing a multiplier circuit).

The prediction determination module 160 may also, for example and without limitation, be adapted to implement the equation:
pred_{C}[x,y]=Clip1((a+b*(x−3)+c*(y−3)+16)>>5) equation 12

with x, y=0 . . . 7, “a” defined by equation 10, “b” defined by equation 4 and “c” defined by equation 8.

As will be exemplified in a non-limiting manner in the system 200 illustrated in FIG. 2, the prediction determination module 160 may comprise a set of addition (and/or difference) circuits, shifters and rounding circuits adapted to implement equation 12 (e.g., without utilizing a multiplier circuit). In various exemplary scenarios, the same set (or substantially the same set) of circuits may be adapted to implement both equations 11 and 12.

Continuing the non-limiting exemplary scenario, during the first time interval, the prediction determination module 160 may receive coefficient “bₗᵤₘₐ” from the horizontal coefficient determination module 110, coefficient “cₗᵤₘₐ” from the vertical coefficient determination module 130 and coefficient “aₗᵤₘₐ” from the horizontal/vertical coefficient determination module 150. The prediction determination module 160 may also receive pixel coordinate information. The prediction determination module 160 may process the received information (e.g., in accordance with equation 11) and output luma prediction information associated with the pixel coordinate information.

Continuing the non-limiting exemplary scenario, during the second time interval, the prediction determination module 160 may receive coefficient “b_{chroma}” from the horizontal coefficient determination module 110, coefficient “c_{chroma}” from the vertical coefficient determination module 130 and coefficient “a_{chroma}” from the horizontal/vertical coefficient determination module 150. The prediction determination module 160 may also receive pixel coordinate information. The prediction determination module 160 may process the received information (e.g., in accordance with equation 12) and output chroma prediction information associated with the pixel coordinate information.

The exemplary system 100 may be implemented in any of a variety of manners. For example and without limitation, the system 100 may be implemented in hardware, software or a combination thereof. Also for example, the exemplary system 100 may be implemented in any of a variety of degrees of integration (e.g., in a single integrated circuit).

For illustrative purposes, the previous discussion presented various aspects of the exemplary system 100 in terms of discrete modules, it should be recognized that the scope of various aspects of the present invention should not be limited by the nature of various modules and/or boundaries between modules. For example and without limitation, various hardware modules may share various hardware components, and various software modules may share various software routines.

In general, the exemplary system 100 was presented to illustrate particular characteristics of generally broader aspects of the present invention. Accordingly, the scope of various aspects of the present invention should not be limited by particular characteristics of the exemplary system 100.

FIG. 2 is a diagram illustrating a system 200 for performing video block prediction, in accordance with various aspects of the present invention. The exemplary system 200 may, for example and without limitation, share various characteristics with the exemplary system 100 illustrated in FIG. 1 and discussed previously. Note, however, that the scope of various aspects of the present invention should not be limited by characteristics of the exemplary system 200.

The exemplary system 200 may comprise a horizontal coefficient determination module 210, a vertical coefficient determination module 230, a horizontal/vertical coefficient determination module 250 and a prediction determination module 260. Also illustrated in FIG. 2, is a plurality of narrow vertical blocks, which generally represent clocked stages of the system 200 (e.g., incorporating clocked flip-flops to synchronize signals at each respective stage).

The exemplary horizontal coefficient determination module 210 may, for example and without limitation, share various characteristics with the horizontal coefficient determination module 110 of the exemplary system 100 illustrated in FIG. 1 and discussed previously.

For example, the first multiplexer 212 and second multiplexer 214 may serially receive (e.g., during a first time interval) first luma information of a plurality of previously decoded horizontal luma pixels. Such first luma information may, in FIG. 2, be labeled P[15,−1]−P[7,−1] and P[−1,−1]−P[6,−1], respectively. Corresponding pairs of the first luma information may be subtracted by the first subtracter 216 (or difference circuit) and processed by two serially connected accumulators with feedback. The first serially connected accumulator comprises the first adder 218 and third multiplexer 220, and the second serially connected accumulator comprises the second adder 222 and fourth multiplexer 224. The output of the second serially connected accumulators may, for example, correspond to “Hₗᵤₘₐ” as indicated in equation 1.

Note that various accumulators shown in FIG. 2 are illustrated with a feedback signal, which is utilized during accumulation operation, and a signal that bypasses the adder, which may be utilized in an initialization operation. This configuration should by no means limit the scope of various aspects of the present invention.

The first shifter 225 shifts Hₗᵤₘₐ by two bits, effectively generating 4*Hₗᵤₘₐ, which the third adder 226 adds to Hₗᵤₘₐ to yield 5*Hₗᵤₘₐ, which is then rounded to six bits by the first rounder 228. The output of the first rounder 228 may, for example, correspond to “bₗᵤₘₐ” as indicated in equation 3.

Also for example, the first multiplexer 212 and second multiplexer 214 may serially receive (e.g., during a second time interval) first chroma information of a plurality of previously decoded horizontal chroma pixels. Such first chroma information may, in FIG. 2, be labeled P[7,−1]−P[4,−1] and P[−1,−1]−P[2,−1], respectively. Corresponding pairs of the first chroma information may be subtracted by the first subtracter 216 and processed by two serially connected accumulators with feedback. The first serially connected accumulator comprises the first adder 218 and third multiplexer, and the second serially connected accumulator comprises the second adder 222 and fourth multiplexer 224. The output of the second serially connected accumulator may, for example, correspond to “H_{chroma}” as indicated in equation 2.

The first shifter 225 shifts H_{chroma} by four bits, effectively generating 16*H_{chroma}, which the third adder 226 adds to H_{chroma} to yield 17*H_{chroma}, which is then rounded to five bits by the first rounder 228. The output of the first rounder 228 may, for example, correspond to “b_{chroma}” as indicated in equation 4.

The exemplary vertical coefficient determination module 230 may, for example and without limitation, share various characteristics with the vertical coefficient determination module 130 of the exemplary system 100 illustrated in FIG. 1 and discussed previously.

For example, the fifth multiplexer 232 and sixth multiplexer 234 may serially receive (e.g., during the first time interval) second luma information of a plurality of previously decoded vertical luma pixels. Such second luma information may, in FIG. 2, be labeled P[−1,15]−P[−1,8] and P[−1,−1]−P[−1,6], respectively. Corresponding pairs of the second luma information may be subtracted by the second subtracter 236 and processed by two serially connected accumulators with feedback. The first serially connected accumulator comprises the fourth adder 238 and seventh multiplexer 240, and the second serially connected accumulator comprises the fifth adder 242 and eighth multiplexer 244. The output of the second serially connected accumulator may, for example, correspond to “Vₗᵤₘₐ” as indicated in equation 5.

The second shifter 245 shifts Vₗᵤₘₐ by two bits, effectively generating 4*Vₗᵤₘₐ, which the sixth adder 246 adds to Vₗᵤₘₐ to yield 5*Vₗᵤₘₐ, which is then rounded to six bits by the second rounder 248. The output of the second rounder 248 may, for example, correspond to “cₗᵤₘₐ” as indicated in equation 7.

Also for example, the fifth multiplexer 232 and sixth multiplexer 234 may serially receive (e.g., during the second time interval) second chroma information of a plurality of previously decoded vertical chroma pixels. Such second chroma information may, in FIG. 2, be labeled P[−1,7]−P[−1,4] and P[−1,−1]−P[−1,2], respectively. Corresponding pairs of the second chroma information may be subtracted by the second subtracter 236 and processed by two serially connected accumulators with feedback. The first serially connected accumulator comprises the fourth adder 238 and seventh multiplexer 240, and the second serially connected accumulator comprises the fifth adder 242 and eighth multiplexer 244. The output of the second serially connected accumulator may, for example, correspond to “V_{chroma}” as indicated in equation 6.

The second shifter 245 shifts V_{chroma} by four bits, effectively generating 16*V_{chroma}, which the sixth adder 246 adds to V_{chroma} to yield 17*V_{chroma}, which is then rounded to five bits by the second rounder 248. The output of the second rounder 248 may, for example, correspond to “c_{chroma}” as indicated in equation 8.

The horizontal/vertical coefficient determination module 250 may, for example and without limitation, share various characteristics with the horizontal/vertical coefficient determination module 150 of the exemplary system 100 illustrated in FIG. 1 and discussed previously.

For example, the seventh adder 252 may receive (e.g., during the first time interval) third luma information of at least one previously decoded horizontal pixel and vertical luma pixel. Such third luma information may, in FIG. 2, be labeled P[−1,15] and P[15,1]. The third luma information may be added by the seventh adder 252 and shifted left by four bits by the third shifter 254 to effectively multiply the sum by sixteen. The output of the third shifter 254 may, for example, correspond to “aₗᵤₘₐ” as indicated in equation 9.

Also for example, the seventh adder 252 may receive (e.g., during the second time interval) third chroma information of at least one previously decoded horizontal pixel and vertical chroma pixel. Such third chroma information may, in FIG. 2, be labeled P[−1,7] and P[7,−1]. The third chroma information may be added by the seventh adder 252 and shifted left by four bits by the third shifter 254 to effectively multiply the sum by sixteen. The output of the third shifter 254 may, for example, correspond to “a_{chroma}” as indicated in equation 10.

The prediction determination module 260 may, for example and without limitation, share various characteristics with the prediction determination module 160 of the exemplary system 100 illustrated in FIG. 1 and discussed previously.

For example, the prediction determination module 260 may (e.g., during the first time interval) receive coefficient “bₗᵤₘₐ” from the horizontal coefficient determination module 210, coefficient “cₗᵤₘₐ” from the vertical coefficient determination module 230, and coefficient “aₗᵤₘₐ” from the horizontal/vertical coefficient determination module 250. The prediction determination module 260 may also receive pixel coordinate information (not shown). Such pixel coordinate information may, for example, comprise horizontal pixel coordinate and vertical pixel coordinate information [x, y]. The prediction determination module 260 may, for example, be adapted to process such received information (e.g., in accordance with equation 11) and output luma prediction information associated with the pixel coordinate information.

For example, an accumulator comprising the eighth adder 262 and the ninth multiplexer 264 may process bₗᵤₘₐ to generate b*x. For example, the accumulator (with feedback) may be cycled “x” times to produce the product b*x. Additionally for example, an accumulator comprising the ninth adder 268 and the tenth multiplexer 270 may process cₗᵤₘₐ to generate c*y. The tenth adder 266 may then add the output of the ninth multiplexer 264 and tenth multiplexer 270 to generate (b*x+c*y). Note that the ninth multiplexer 264 and the tenth multiplexer 270 each have “0” inputs, which may be utilized during initialization. This particular configuration should not limit the scope of various aspects of the present invention.

The eleventh adder 274 adds the output of the first rounder 228 and the second rounder 248 to generate (a+b) and provides such (a+b) to the twelfth adder 272 and the fourth shifter 276. The twelfth adder 272 outputs the sum (a+b+c), and the fourth shifter 276 shifts (a+b) left by three bits and outputs 8*(a+b). The third subtracter 278 subtracts the output of the fourth shifter 276 from the output of the twelfth adder 272, thus generating (a−7*(b+c)). The thirteenth adder 280 adds the outputs from the tenth adder 266 and the third subtracter 278, which is then rounded by the third rounder 282 to five bits to implement equation 11 for luma pixel prediction.

Further for example, the prediction determination module 260 may (e.g., during the second time interval) receive coefficient “b_{chroma},” from the horizontal coefficient determination module 210, coefficient “c_{chroma}” from the vertical coefficient determination module 230 and coefficient “a_{chroma}” from the horizontal/vertical coefficient determination module 250. The prediction determination module 260 may also receive pixel coordinate information (not shown). Such pixel coordinate information may, for example, comprise horizontal pixel coordinate and vertical pixel coordinate information [x, y]. The prediction determination module 260 may, for example, be adapted to process such received information (e.g., in accordance with equation 12) and output chroma prediction information associated with the pixel coordinate information.

For example, an accumulator comprising the eighth adder 262 and the ninth multiplexer 264 may process b_{chroma} to generate b*x. Additionally for example, an accumulator comprising the ninth adder 268 and the tenth multiplexer 270 may process c_{chroma} to generate c*y. The tenth adder 266 may then add the output of the ninth multiplexer 264 and tenth multiplexer 270 to generate (b*x+c*y).

The eleventh adder 274 adds the output of the first rounder 228 and the second rounder 248 to generate (a+b) and provides such (a+b) to the twelfth adder 272 and the fourth shifter 276. The twelfth adder 272 outputs the sum (a+b+c), and the fourth shifter 276 shifts (a+b) left by two bits and outputs 4*(a+b). The third subtracter 278 subtracts the output of the fourth shifter 276 from the output of the twelfth adder 272, thus generating (a−3*(b+c)). The thirteenth adder 280 adds the outputs from the tenth adder 266 and the third subtracter 278, which is then rounded by the third rounder 282 to five bits to implement equation 12 for chroma pixel prediction.

The exemplary system 200 was presented to illustrate particular characteristics of generally broader aspects of the present invention. Accordingly, the scope of various aspects of the present invention should not be limited by particular characteristics of the exemplary system 200.

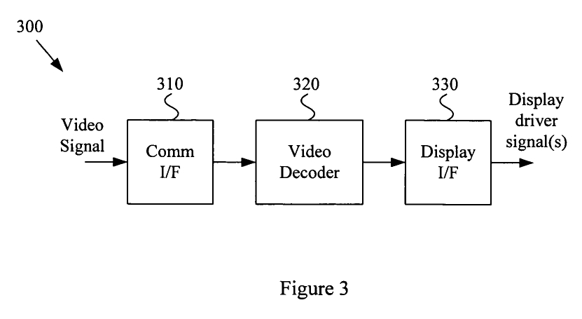

FIG. 3 is a diagram illustrating a video processing system 300, in accordance with various aspects of the present invention. The exemplary video processing system 300 may, for example and without limitation, share various characteristics with the exemplary systems 100, 200 illustrated in FIGS. 1-2 and discussed previously.

The exemplary video processing system 300 may, for example, comprise a communication interface module 310, a video decoder module 320 and a display interface module 330. The communication interface module 310 may comprise characteristics of any of a variety of types of communication interface modules. For example and without limitation, the communication interface module 310 may be adapted to receive video information from any of a variety of video information sources. For example, the communication interface module 310 may be adapted to received one or more video signals from a satellite communication system, a cable television system, a computer communication system (e.g., a LAN or the Internet), a video information storage system, etc. Accordingly, the scope of various aspects of the present invention should not be limited by characteristics of any particular communication interface module.

The video decoder module 320 may, for example, be adapted to receive one or more encoded video signals from the communication interface module 310, decode such video signals and output corresponding decoded video signals. The video decoder module 320 may comprise characteristics of any of a variety of video decoder modules or sub-modules. For example and without limitation, the video decoder module 320 may comprise a module or sub-module comprising various characteristics of the exemplary systems 100, 200 illustrated in FIGS. 1-2 and discussed previously.

The display interface module 330 may be adapted to receive decoded video signals from the decoder module 320 and output at least one display driver signal representative of one or more encoded video signals received by the communication interface module 310 and decoded by the video decoder module 320.

The previous exemplary video processing system 300 was presented to provide specific illustrations of various generally broader aspects of the present invention. Accordingly, the scope of various aspects of the present invention should not be limited by characteristics of the previously discussed exemplary system 300.

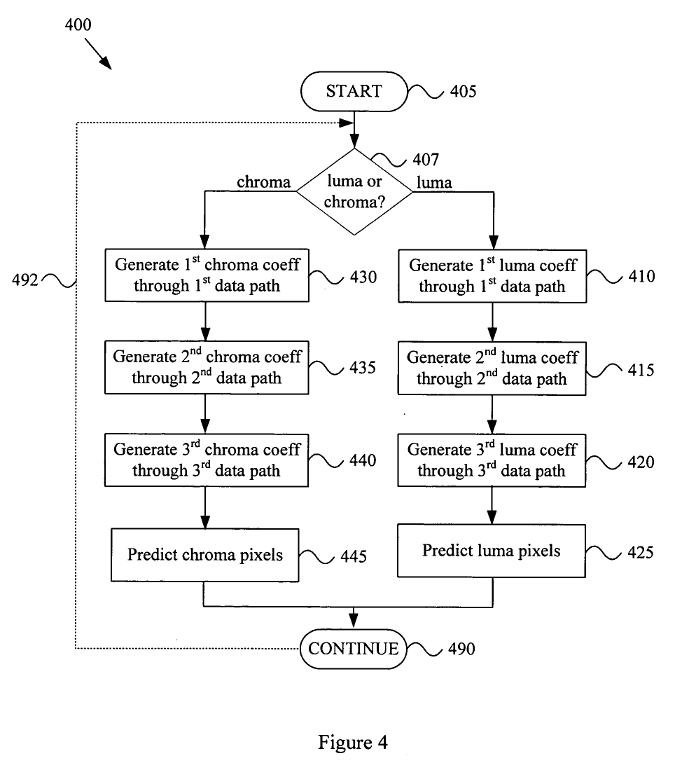

FIG. 4 is a flow diagram illustrating a method 400 for performing video block prediction, in accordance with various aspects of the present invention. The exemplary method 400 may, for example and without limitation, share various functional characteristics with the exemplary systems 100, 200, 300 illustrated in FIGS. 1-3 and discussed previously.

The exemplary method 400 may begin execution at step 405. The exemplary method 400 may begin executing for any of a large variety of reasons. For example and without limitation, the exemplary method 400 may begin executing in response to a system implementing the method 400 being reset or powered up. Also for example, the exemplary method 400 may begin executing in response to a command, which may, for example, be received from a user or another system. Further for example, the exemplary method 400 may begin executing in response to the arrival of decoded video information. Accordingly, the scope of various aspects of the present invention should not be limited by characteristics of any particular initiating cause or condition.

The exemplary method 400 may, at step 407, comprise directing execution flow of the exemplary method 400. For example, in an exemplary scenario where a luma pixel prediction is to be performed, step 407 may comprise directing execution flow of the exemplary method 400 to step 410. Also for example, in an exemplary scenario where a chroma pixel prediction is to be performed, step 470 may comprise directing execution flow of the exemplary method 400 to step 430.

The exemplary method 400 may, at step 410, comprise (e.g., during a first time period) generating a first luma prediction coefficient by processing previously decoded horizontal luma pixel information through a first data path. Step 410 may, for example and without limitation share various functional characteristics with the horizontal coefficient determination modules 110, 210 of the exemplary systems 100, 200 illustrated in FIGS. 1-2 and discussed previously.

For example and without limitation, step 410 may comprise processing horizontal luma pixel information through a first data path by propagating the horizontal luma pixel information through a first serial data path utilizing serially connected accumulators to implement equation 1 (e.g., without utilizing a multiplier circuit). Also for example, step 410 may comprise processing Hₗᵤₘₐ (e.g., from equation 1) in the first serial data path utilizing at least an adder and a shift register to implement equation 3 (e.g., without utilizing a multiplier circuit).

The exemplary method 400 may, at step 415, comprise (e.g., during the first time period) generating a second luma prediction coefficient by processing previously decoded vertical luma pixel information through a second data path. Step 415 may, for example and without limitation, share various functional characteristics with the vertical coefficient determination modules 130, 230 of the exemplary systems 100, 200 illustrated in FIGS. 1-2 and discussed previously.

For example and without limitation, step 415 may comprise processing vertical luma pixel information through a second data path by propagating the vertical luma pixel information through a second serial data path utilizing serially connected accumulators to implement equation 5 (e.g., without utilizing a multiplier circuit). Also for example, step 415 may comprise processing Vₗᵤₘₐ (e.g., from equation 5) in the second serial data path utilizing at least an adder and a shift register to implement equation 7 (e.g., without utilizing a multiplier circuit).

The exemplary method 400 may, at step 420, comprise (e.g., during the first time period) generating a third luma prediction coefficient by processing previously decoded horizontal luma pixel information and vertical luma pixel information through a third data path. Step 420 may, for example and without limitation, share various functional characteristics with the horizontal/vertical coefficient determination modules 150, 250 of the exemplary systems 100, 200 illustrated in FIGS. 1-2 and discussed previously.

For example and without limitation, step 420 may comprise generating a third luma prediction coefficient by processing previously decoded horizontal luma pixel information and vertical luma pixel information in a third serial data path utilizing at least an adder and a shift register to implement equation 9 (e.g., without utilizing a multiplier circuit).

The exemplary method 400 may, at step 425, comprise (e.g., during the first time period) generating a luma pixel prediction based, at least in part, on the first luma prediction coefficient, the second luma prediction coefficient, the third luma prediction coefficient and pixel coordinate information. Step 425 may, for example and without limitation, share various functional characteristics with the prediction determination modules 160, 260 of the exemplary systems 100, 200 illustrated in FIGS. 1-2 and discussed previously. For example, step 425 may comprise utilizing various adders, multiplexers and shift registers to implement equation 11 (e.g., without utilizing a multiplier circuit).

The exemplary method 400 may, at step 430, comprise (e.g., during a second time period) generating a first chroma prediction coefficient by processing previously decoded horizontal chroma pixel information through a first data path (e.g., the same or substantially the same first data path utilized at step 410). For example and without limitation, step 430 may share various functional characteristics with the horizontal coefficient determination modules 110, 210 of the exemplary systems 100, 200 illustrated in FIGS. 1-2 and discussed previously.

For example and without limitation, step 430 may comprise processing horizontal chroma pixel information through the first data path by propagating the horizontal chroma pixel information through a first serial data path (e.g., the same or substantially the same first serial data path that may be used at step 410) utilizing serially connected accumulators to implement equation 2 (e.g., without utilizing a multiplier circuit). Also for example, step 430 may comprise processing H_{chroma} (e.g., from equation 2) in the first serial data path utilizing at least an adder and a shift register to implement equation 4 (e.g., without utilizing a multiplier circuit).

The exemplary method 400 may, at step 435, comprise (e.g., during the second time period) generating a second chroma prediction coefficient by processing vertical chroma pixel information through a second data path (e.g., the same or substantially the same second data path utilized at step 415). Step 435 may, for example and without limitation, share various functional characteristics with the vertical coefficient determination modules 130, 230 of the exemplary systems 100, 200 illustrated in FIGS. 1-2 and discussed previously.

For example and without limitation, step 435 may comprise processing vertical chroma pixel information through the second data path by propagating the vertical chroma pixel information through a second serial data path (e.g., the same or substantially the same second serial data path that may be used at step 415) utilizing serially connected accumulators to implement equation 6 (e.g., without utilizing a multiplier circuit). Also for example, step 435 may comprise processing V_{chroma} (e.g., from equation 6) in the second serial data path utilizing at least an adder and a shift register to implement equation 8 (e.g., without utilizing a multiplier circuit).

The exemplary method 400 may, at step 440, comprise (e.g., during the second time period) generating a third chroma prediction coefficient by processing previously decoded horizontal chroma pixel information and vertical chroma pixel information through a third data path (e.g., the same or substantially same third data path utilized at step 420). Step 440 may, for example and without limitation, share various functional characteristics with the horizontal/vertical coefficient determination modules 150, 250 of the exemplary systems 100, 200 illustrated in FIGS. 1-2 and discussed previously.

For example and without limitation, step 440 may comprise generating a third chroma prediction coefficient by processing previously decoded horizontal chroma pixel information and vertical chroma pixel information in a third serial data path (e.g., the same or substantially the same third serial data path that may be utilized by step 420) utilizing at least an adder and a shift register to implement equation 10 (e.g., without utilizing a multiplier circuit).

The exemplary method 400 may, at step 445, comprise (e.g., during the second time period) generating a chroma pixel prediction based, at least in part, on the first chroma prediction coefficient, the second chroma prediction coefficient, the third chroma prediction coefficient and pixel coordinate information. Step 445 may, for example and without limitation, share various functional characteristics with the prediction determination modules 160, 260 of the exemplary systems 100, 200 illustrated in FIGS. 1-2 and discussed previously. For example, step 445 may comprise utilizing various adders, multiplexers and shift registers to implement equation 12 (e.g., without utilizing a multiplier circuit).

The exemplary method 400 may, at step 490, comprise performing continued processing. Such continued processing may comprise characteristics of any of a large variety of continued processing. For example and without limitation, step 490 may share various functional characteristics with the exemplary systems 100, 200, 300 illustrated in FIGS. 1-3 and discussed previously.

For example and without limitation step 490 may comprise processing predicted pixel information (e.g., as predicted at steps 425 and 445) to generate one or more display driver signals. Step 490 may also, for example, as indicated by dashed line 492, comprise looping execution flow of the exemplary method 400 back up to step 407 for a next chroma or luma pixel prediction. In various exemplary scenarios that include the prediction of additional luma or chroma pixel information, step 490 may comprise resetting various software and/or hardware components utilized to perform the prediction. Step 490 may further, for example, comprise interfacing with another system or user to determine various video-processing characteristics.

In general, step 490 may comprise performing continued processing. Accordingly, the scope of various aspects of the present invention should not be limited by characteristics of any particular type of continued processing.

Exemplary method 400 was presented to provide specific illustrations of various generally broader aspects of the present invention. Accordingly, the scope of various aspects of the present invention should not be limited by characteristics of the previously discussed exemplary method 400.

In summary, various aspects of the present invention provide a system and method for performing video block prediction. While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A video processing system for performing video block prediction, the system comprising:
a first module that is adapted to receive, during a first time interval, first luma information of a plurality of previously decoded horizontal luma pixels and calculate a first luma prediction coefficient based, at least in part, on the first luma information;
a second module that is adapted to receive, during the first time interval, second luma information of a plurality of previously decoded vertical luma pixels and calculate a second luma prediction coefficient based, at least in part, on the second luma information;
a third module that is adapted to receive, during the first time interval, third luma information of at least one previously decoded horizontal luma pixel and vertical luma pixel, and calculate a third luma prediction coefficient based, at least in part, on the third luma information; and
a fourth module that is adapted to:
receive, during the first time interval, the first luma prediction coefficient, the second luma prediction coefficient, the third luma prediction coefficient and pixel coordinate information; and
generate a luma pixel prediction value corresponding to the pixel coordinate information.

2. The video processing system of claim 1, wherein:
the first module is further adapted to receive, during a second time interval, first chroma information of a plurality of previously decoded horizontal chroma pixels and calculate a first chroma prediction coefficient based, at least in part, on the first chroma information;
the second module is further adapted to receive, during the second time interval, second chroma information of a plurality of previously decoded vertical chroma pixels and calculate a second chroma prediction coefficient based, at least in part, on the second chroma information;
the third module is further adapted to receive, during the second time interval, third chroma information of at least one previously decoded horizontal chroma pixel and vertical chroma pixel, and calculate a third chroma prediction coefficient based, at least in part, on the third chroma information; and
the fourth module is further adapted to:
receive, during the second time interval, the first chroma prediction coefficient, the second chroma prediction coefficient, the third chroma prediction coefficient and pixel coordinate information; and
generate a chroma pixel prediction value corresponding to the pixel coordinate information.

3. The video processing system of claim 1, wherein:
the first module comprises a first set of serially connected accumulators adapted to calculate
$${H}_{luma} = {\sum }_{{x}^{′} = 0}^{7} ( {x}^{′} + 1 ) * ( p [ 8 + {x}^{′} , - 1 ] - p [ 6 - {x}^{′} , - 1 ] )$$
without utilizing a multiplier circuit; and
the second module comprises serially connected accumulators adapted to calculate
$${V}_{luma} = {\sum }_{{y}^{′} = 0}^{7} ( {y}^{′} + 1 ) * ( p [ - 1 , 8 + {y}^{′} ] - p [ - 1 , 6 - {y}^{′} ] )$$
without utilizing a multiplier circuit.

4. The video processing system of claim 3, wherein:
the first set of serially connected accumulators is further adapted to calculate
$${H}_{chroma} = {\sum }_{{x}^{′} = 0}^{3} ( {x}^{′} + 1 ) * ( p [ 4 + {x}^{′} , - 1 ] - p [ 2 - {x}^{′} , - 1 ] )$$
without utilizing a multiplier circuit; and
the second set of serially connected accumulators is further adapted to calculate
$${V}_{chroma} = {\sum }_{{y}^{′} = 0}^{3} ( {y}^{′} + 1 ) * ( p [ - 1 , 4 + {y}^{′} ] - p [ 1 , 2 - {y}^{′} ] )$$
without utilizing a multiplier circuit.

5. The video processing system of claim 3, wherein:
the first module comprises an adder and shift register that are adapted to calculate
bₗᵤₘₐ=(5*Hₗᵤₘₐ+32)>>6
without utilizing a multiplier circuit; and
the second module comprises an adder and shift register that are adapted to calculate
cₗᵤₘₐ=(5*Vₗᵤₘₐ+32)>>6
without utilizing a multiplier circuit.

6. The video processing system of claim 5, wherein:
the adder and the shift register of the first module are further adapted to calculate
b_{chroma}=(17*H_{chroma}+16)>>5
without utilizing a multiplier circuit; and
the adder and the shift register of the second module are further adapted to calculate
c_{chroma}=(17*V_{chroma}+16)>>5
without utilizing a multiplier circuit.

7. The video processing system of claim 1, wherein the fourth module comprises adder circuits, accumulators, shift registers and subtracter circuits adapted to generate the luma pixel prediction value without utilizing a multiplier circuit.

8. The video processing system of claim 1, further comprising:
a video input interface adapted to receive encoded video information from a communication system;
a video decoder module adapted to decode received encoded video information, wherein the video decoder module comprises the first module, the second module, the third module and the fourth module; and
a video output interface adapted to receive decoded video information and generate at least one display driver signal corresponding to the decoded video information.

9. The video processing system of claim 1, wherein the first module, second module, third module and fourth module are integrated in a single integrated circuit.

10. A video processing system for performing video block prediction, the system comprising:
a first module adapted to:
during a first time interval, receive first luma information of a plurality of previously decoded horizontal luma pixels and propagate the first luma information through a first data path to generate a first luma prediction coefficient; and
during a second time interval, receive first chroma information of a plurality of previously decoded horizontal chroma pixels and propagate the first chroma information through the first data path to generate a first chroma prediction coefficient; and
a second module, coupled to the first module, adapted to:
receive prediction coefficient information from the first module and pixel coordinate information; and
generate, based at least in part on the received prediction coefficient information, pixel prediction information for pixel(s) corresponding to the received pixel coordinate information.

11. The video processing system of claim 10, wherein the first module is further adapted to:
during a first time interval, receive second luma information of a plurality of previously decoded vertical luma pixels and propagate the second luma information through a second data path to generate a second luma prediction coefficient; and
during a second time interval, receive second chroma information of a plurality of previously decoded vertical chroma pixels and propagate the second chroma information through the second data path to generate a second chroma prediction coefficient.

12. The video processing system of claim 10, wherein the first data path comprises addition circuitry and subtracter circuitry to implement equations comprising:
$${H}_{luma} = {\sum }_{{x}^{′} = 0}^{7} ( {x}^{′} + 1 ) * ( p [ 8 + {x}^{′} , - 1 ] - p [ 6 - {x}^{′} , - 1 ] ) ; and$$
$${H}_{chroma} = {\sum }_{{x}^{′} = 0}^{3} ( {x}^{′} + 1 ) * ( p [ 4 + {x}^{′} , - 1 ] - p [ 2 - {x}^{′} , - 1 ] ) ,$$
in the absence of multiplier circuitry.

13. The video processing system of claim 10, wherein the second data path comprises second addition circuitry and second subtracter circuitry to implement equations comprising:
$${V}_{luma} = {\sum }_{{y}^{′} = 0}^{7} ( {y}^{′} + 1 ) * ( p [ - 1 , 8 + {y}^{′} ] - p [ - 1 , 6 - {y}^{′} ] ) ; and$$
$${V}_{chroma} = {\sum }_{{y}^{′} = 0}^{3} ( {y}^{′} + 1 ) * ( p [ - 1 , 4 + {y}^{′} ] - p [ - 1 , 2 - {y}^{′} ] ) ,$$
in the absence of multiplier circuitry.

14. The video processing system of claim 10, wherein the first data path utilizes serially-connected accumulators to generate a prediction coefficient based on a series of terms that include multiplication operations.

15. A method of processing video information, the method comprising:
during a first time period:
generating a first luma prediction coefficient by processing previously decoded horizontal luma pixel information through a first data path; and
generating a second luma prediction coefficient by processing previously decoded vertical luma pixel information through a second data path; and
during a second time period:
generating a first chroma prediction coefficient by processing previously decoded horizontal chroma pixel information through the first data path; and
generating a second chroma prediction coefficient by processing previously decoded vertical chroma pixel information through the second data path.

16. The method of claim 15, further comprising:
during the first time period:
generating a third luma prediction coefficient by processing previously decoded horizontal luma pixel information and vertical luma pixel information through a third data path; and
generating a luma pixel prediction based, at least in part, on the first luma prediction coefficient, the second luma prediction coefficient, the third luma prediction coefficient and pixel coordinate information; and
during the second time period:
generating a third chroma prediction coefficient by processing previously decoded horizontal chroma pixel information and vertical chroma pixel information through the third data path; and
generating a chroma pixel prediction based, at least in part, on the first chroma prediction coefficient, the second chroma prediction coefficient, the third chroma prediction coefficient and pixel coordinate information.

17. The method of claim 15, wherein:
processing horizontal luma pixel information through a first data path comprises propagating the horizontal luma pixel information through a first serial data path utilizing serially connected accumulators to implement the equation
$${H}_{luma} = {\sum }_{{x}^{′} = 0}^{7} ( {x}^{′} + 1 ) * ( p [ 8 + {x}^{′} , - 1 ] - p [ 6 - {x}^{′} , - 1 ] )$$
without utilizing a multiplier circuit; and
processing vertical luma pixel information through a second data path comprises propagating the vertical luma pixel information through a second serial data path utilizing serially connected accumulators to implement the equation
$${V}_{luma} = {\sum }_{{y}^{′} = 0}^{7} ( {y}^{′} + 1 ) * ( p [ - 1 , 8 + {y}^{′} ] - p [ - 1 , 6 - {y}^{′} ] )$$
without utilizing a multiplier circuit.

18. The method of claim 17, wherein:
processing horizontal chroma pixel information through the first data path comprises propagating the horizontal chroma pixel information through the first serial data path utilizing serially connected accumulators to implement the equation
$${H}_{chroma} = {\sum }_{{x}^{′} = 0}^{3} ( {x}^{′} + 1 ) * ( p [ 4 + {x}^{′} , - 1 ] - p [ 2 - {x}^{′} , - 1 ] )$$
without utilizing a multiplier circuit; and
processing vertical chroma pixel information through the second data path comprises propagating the vertical luma pixel information through the second serial data path utilizing serially connected accumulators to implement the equation
$${V}_{chroma} = {\sum }_{{y}^{′} = 0}^{3} ( {y}^{′} + 1 ) * ( p [ - 1 , 4 + {y}^{′} ] - p [ - 1 , 2 - {y}^{′} ] )$$
without utilizing a multiplier circuit.

19. The method of claim 17, wherein:
generating a first luma prediction coefficient comprises processing Hₗᵤₘₐ in the first serial data path utilizing at least an adder and a shift register to implement the equation
bₗᵤₘₐ=(5*Hₗᵤₘₐ+32)>>6
without utilizing a multiplier circuit;
generating a second luma prediction coefficient comprises processing Vₗᵤₘₐ in the second serial data path utilizing at least an adder and a shift register to implement the equation
cₗᵤₘₐ=(5*Vₗᵤₘₐ+32)>>6
without utilizing a multiplier circuit;
generating a third luma prediction coefficient comprises processing previously decoded horizontal luma pixel information and vertical luma pixel information in a third serial data path utilizing at least an adder and a shift register to implement the equation
aₗᵤₘₐ=16*(p[−1,15]+p[15,−1])
without utilizing a multiplier circuit.

20. The method of claim 18, wherein:
generating a first chroma prediction coefficient comprises processing H_{chroma} in the first data path utilizing at least an adder and a shift register to implement the equation
b_{chroma}=(17*H_{chroma}+16)>>5
without utilizing a multiplier circuit;
generating a second chroma prediction coefficient comprises processing V_{chroma} in the second serial data path utilizing at least an adder and a shift register to implement the equation
c_{chroma}=(17*V_{chroma}+16)>>5
without utilizing a multiplier circuit; and
generating a third chroma prediction coefficient comprises processing previously decoded horizontal chroma pixel information and vertical chroma pixel information in a third serial data path utilizing at least an adder and a shift register to implement the equation
a_{chroma}=16*(p−[1,7]+p[7,−1])
without utilizing a multiplier circuit.

21. A video processing system for performing video block prediction, the system comprising:
at least one module that is adapted to:
calculate a plurality of luma prediction coefficients based, at least in part, on previously decoded luma information; and
generate a luma pixel prediction value based at least in part on the plurality of luma prediction coefficients and corresponding to received pixel coordinate information.
